(19) United States
(12) Patent Application Publication
(10) Pub. No.: US 2007/0126209 A1
(43) Pub. Date: Jun. 7, 2007

(54) Convertible trailer

(76) Inventor: Arnold R. Wolfe, Gasport, NY (US)

Correspondence Address: Robert C. Atkinson;Simpson & Simpson, PLLC, 5555 Main Street, Williamsville, NY, 14221, US

(21) Appl. No.: 11/633,273

(22) Filed: Dec. 1, 2006

Related U.S. Application Data
(60) Provisional application No. 60/742,397, filed on Dec. 5, 2005.

(51) Int. Cl. B62B 5/00

(52) U.S. Cl. 280/656

(57) ABSTRACT

An apparatus which can be configured to be a trailer and a shed including a trailer frame, a trailer hitch arm collapsably connected to the trailer frame, a floor attached substantially planar with the frame, at least two side walls connected to the floor, wherein the walls are arranged perpendicular to the floor, at least one door attached to one of the side walls by a first hinge, a tailgate attached to the trailer by a second hinge, wherein the tailgate provides a substantially planar surface that can function as a floor for the shed and a tailgate for the trailer and an axle having at least two wheels, the axle pivotably connected to the trailer frame, wherein the axle pivots into a down position to provide the trailer with an extended axle and wheels, and the axle pivots into an up position to provide the trailer with a substantially planar base with a retracted axle and wheels.

### CROSS REFERENCE TO RELATED APPLICATION

This patent application claims the benefit under 35 U.S.C. §119(e) of U.S. Provisional Application No. 60/742,397, filed Dec. 5, 2005, which application is incorporated herein by reference.

### FIELD OF THE INVENTION

This invention relates generally to trailers, more specifically to a trailer having retractable wheels and tow arm, and even more specifically to a trailer having retractable wheels and tow arm that can be converted into a storage container.

### BACKGROUND OF THE INVENTION

Trailers designed to haul various loads are diverse and plentiful. Trailers often include a frame, whereon an axle having at least two wheels is mounted. Some trailers may include a flat platform secured to the top of the frame for carrying various items, while other trailers may include side walls, front walls, back walls and/or tailgates. Trailers may be covered with a hard top cover or merely covered with a tarp. Trailers of these types are often used by people such as hunters, campers, weekend home repair do-it-yourselfers and landscapers. Although these trailers may be used for transporting a multitude of objects, materials, etc., studies have shown that due to trailer storage requirements and their unsightly appearances, consumers are often reluctant to purchase such trailers.

Exterior storage space can cost a significant amount of money, as reflected in the burgeoning exterior storage rental industry. Exterior storage containers may take any number of forms and sizes, e.g., from small storage sheds to flat-bed truck containers. Exterior storage containers provide added storage space, but are often difficult to move from one location to another, and thus often become permanent structures after installation or initial use.

Unfortunately, the aforementioned trailers are not capable of providing an exterior storage container which is also aesthetically appealing. Similarly, the aforementioned storage containers are not capable of being transported between locations.

Thus, there is a long felt need for an affordable, multipurpose storage apparatus capable of being easily transported from one location to another, including across substantial distances. Additionally, there is a long felt need for an aesthetically appealing, transportable storage apparatus.

### SUMMARY OF THE INVENTION

The present invention broadly comprises an apparatus which can be configured to be a trailer and a shed, including a trailer frame, a trailer hitch arm collapsably connected to the trailer frame, a floor attached substantially planar with the frame, at least two side walls connected to the floor, wherein the walls are arranged perpendicular to the floor, at least one door attached to one of the side walls by a first hinge, a tailgate attached to the trailer by a second hinge, wherein the tailgate provides a substantially planar surface that can function as a floor for the shed and a tailgate for the trailer and an axle having at least two wheels, the axle pivotably connected to the trailer frame, wherein the axle pivots into a down position to provide the trailer with an extended axle and wheels, and the axle pivots into an up position to provide the trailer with a substantially planar base with a retracted axle and wheels. In one embodiment, the apparatus further includes at least one shelf detachably positioned between, and perpendicular to, the side walls. In another embodiment, the apparatus further includes a retaining element to hold the axle in the down or up position. In a further embodiment, the apparatus includes at least one handle attached to the axle operatively arranged to assist in pivoting the axle into the up position, while in yet a further embodiment, the apparatus includes at least one handle attached to the axle, operatively arranged to assist in pivoting the axle into the down position. In still a further embodiment, collapsing the trailer hitch arm toward the frame locks the axle in the up position. In another embodiment, the trailer hitch arm is pivotably connected to the trailer frame, while in yet another embodiment, the trailer hitch arm is telescopically connected to the trailer frame. And in still yet a further embodiment, the telescoping trailer hitch arm locks the axle in the up position when the trailer hitch arm is telescoped inwardly, and the trailer hitch arm locks the axle in the down position when the trailer hitch arm is telescoped outwardly.

The present invention also broadly comprises an apparatus, including a trailer frame, a floor attached to the frame, at least two side walls connected to the trailer frame, a rear wall pivotably connected to the trailer frame, a trailer hitch arm collapsably connected to the trailer frame, distal to the rear wall and an axle having at least two wheels, the axle pivotably connected to the trailer frame having a retracted and an extended position, wherein in a trailer orientation the trailer frame is horizontally oriented, the trailer hitch arm is extended, and the axle is in the extended position, and wherein in a shed orientation the trailer frame is vertically oriented, the trailer hitch arm is collapsed, and the axle is in the retracted position. In one embodiment, the apparatus further includes a retaining element to hold the axle in the retracted or extended positions. And in another embodiment, collapsing the trailer hitch arm adjacent to the frame locks the axle in the retracted position. In a further embodiment, the apparatus includes at least one handle attached to the axle operatively arranged to assist in pivoting the axle into the retracted position, while in yet a further embodiment, the apparatus includes at least one handle attached to the axle operatively arranged to assist in pivoting the axle into the extended position. In still further embodiments, the trailer hitch arm is pivotably or telescopically connected to the trailer frame. In yet still another embodiment, the trailer hitch arm locks the axle in the retracted position when the trailer hitch arm is telescoped inwardly, and the trailer hitch arm locks the axle in the extended position when the trailer hitch arm is telescoped outwardly.

Another embodiment of the present invention comprises an apparatus which can be configured to be a trailer and a shed, including a trailer frame, a floor attached substantially planar with the frame, at least two side walls connected to the floor, wherein the walls are arranged perpendicular to the floor, a tailgate attached to the trailer by a hinge, wherein the tailgate provides a substantially planar surface that can function as a floor for the shed and a tailgate for the trailer, an axle having at least two wheels, the axle pivotably connected to the trailer frame, wherein the axle pivots into a down position to provide the trailer with an extended axle and wheels, and the axle pivots into an up position to provide the trailer with a substantially planar base with a retracted axle and wheels and a trailer hitch arm telescopically connected to the trailer frame, wherein the trailer hitch arm locks the axle in the up position when the trailer hitch arm is telescoped inwardly, and the trailer hitch arm locks the axle in the down position when the trailer hitch arm is telescoped outwardly.

Yet another embodiment of the present invention comprises an apparatus which can be configured to be a trailer and a shed, including a trailer frame, a floor attached substantially planar with the frame, at least two side walls connected to the floor, wherein the walls are arranged perpendicular to the floor, a tailgate attached to the trailer by a hinge, wherein the tailgate provides a substantially planar surface that can function as a floor for the shed and a tailgate for the trailer, an axle having at least two wheels, the axle pivotably connected to the trailer frame, wherein the axle pivots into a down position to provide the trailer with an extended axle and wheels, and the axle pivots into an up position to provide the trailer with a substantially planar base with a retracted axle and wheels and a trailer hitch arm mechanically connected to the trailer frame, wherein the trailer hitch arm is linked to the axle, wherein movement of the trailer hitch arm inwardly pivots the axle into the up position, and movement of the trailer hitch arm outwardly pivots the axle into a down position.

It is therefore a general object of the invention to provide a convenient storage apparatus which may be easily transported by a vehicle.

It is another object of the invention to provide a transportable storage apparatus which is simple to use, easy to clean, low maintenance and has an aesthetically appealing appearance.

It is another object of the invention to provide a transportable storage apparatus which has a water proof exterior shell, lightweight construction, large capacity and removable storage shelves.

These and other objects, features, and advantages of the present invention will become readily apparent to those having ordinary skill in the art upon reading the following detailed description of the invention in view of the several drawings of the invention.

### BRIEF DESCRIPTION OF THE DRAWINGS

The nature and mode of operation of the present invention will now be more fully described in the following detailed description of the invention taken with the accompanying drawing figures, in which:

FIG. 1 is a perspective view of an embodiment of a present invention convertible trailer in a storage configuration including closed doors;

FIG. 2 is a perspective view of an embodiment of a present invention convertible trailer in a storage configuration including open doors;

FIG. 3 is a perspective view of an embodiment of a present invention convertible trailer in a towing configuration including closed doors;

FIG. 4 is a perspective view of an embodiment of a present invention convertible trailer in a towing configuration including open doors and an extended front portion;

FIG. 5 is a perspective view of an embodiment of a present invention convertible trailer in a towing configuration including open doors, an extended front portion and an open tailgate;

FIG. 6 is an exploded view of an embodiment of a present invention convertible trailer in a towing configuration;

FIG. 7 is a perspective view of an embodiment of a present invention convertible trailer in a towing configuration without doors, top portion or tailgate and having a tow arm in an extended position;

FIG. 8 is a perspective view of an embodiment of a present invention convertible trailer in a towing configuration without doors, front portion or tailgate and having a tow arm in a retracted position;

FIG. 9 is an exploded view of an embodiment of a present invention convertible trailer having a telescoping tow arm;

FIG. 10 is a side elevational view of an embodiment of a present invention convertible trailer having a telescoping tow arm and wheel axle in an extended position;

FIG. 11 is a side elevational view of an embodiment of a present invention convertible trailer having a telescoping tow arm and wheel axle in a retracted position;

FIG. 12 is a perspective view of an embodiment of a present invention convertible trailer having a hinged tow arm in an extended position and a wheel axle in a retracted position;

FIG. 13 is a perspective view of an embodiment of a present invention convertible trailer having a hinged tow arm in a retracted position and a wheel axle in a retracted position;

FIG. 14 is a side elevational view of an embodiment of a present invention convertible trailer having a hinged tow arm and wheel axle in an extended position; and,

FIG. 15 is a side elevational view of an embodiment of a present invention convertible trailer having a hinged tow arm and wheel axle in a retracted position.

### DETAILED DESCRIPTION OF THE INVENTION

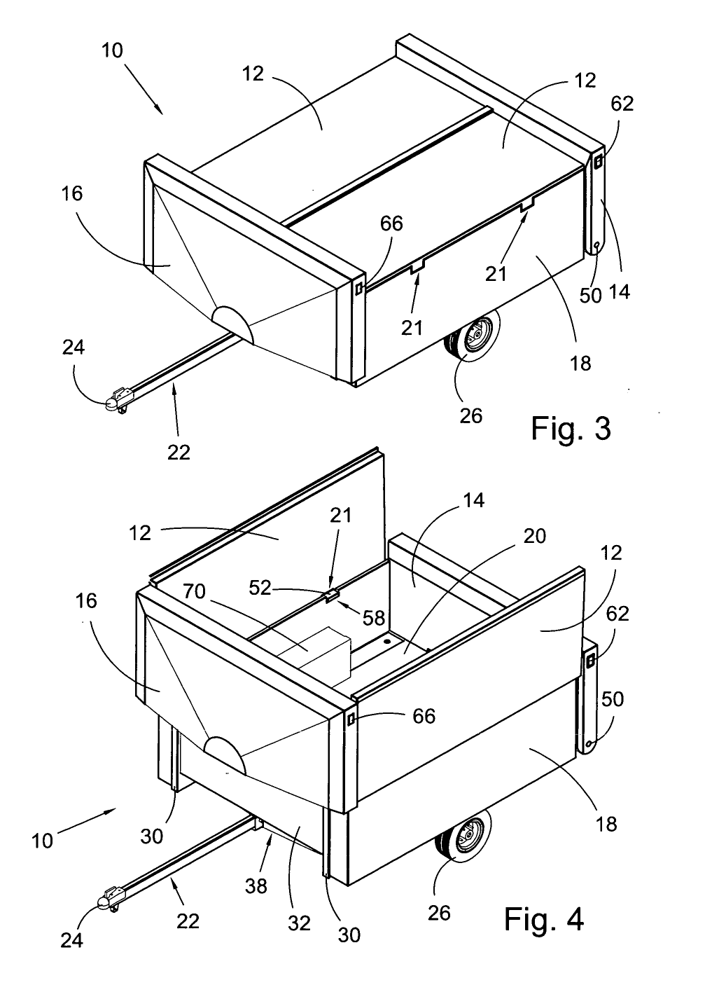

At the outset, it should be appreciated that like drawing numbers on different drawing views identify identical structural elements of the invention. While the present invention is described with respect to what is presently considered to be the preferred embodiments, it is understood that the invention is not limited to the disclosed embodiments. In the description below, the terms “upper”, “lower”, “front”, “back”, “left”, “right”, and their derivatives, should be interpreted from the perspective of one viewing the convertible trailer shown in FIG. 3.

Furthermore, it is understood that this invention is not limited to the particular methodology, materials and modifications described and as such may, of course, vary. It is also understood that the terminology used herein is for the purpose of describing particular embodiments only, and is not intended to limit the scope of the present invention.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the preferred methods, devices, and materials are now described.

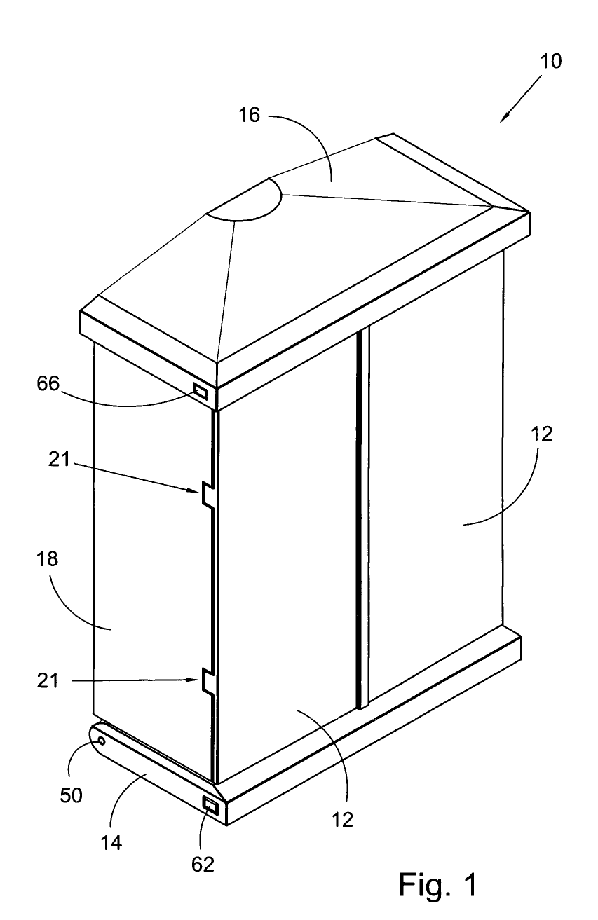

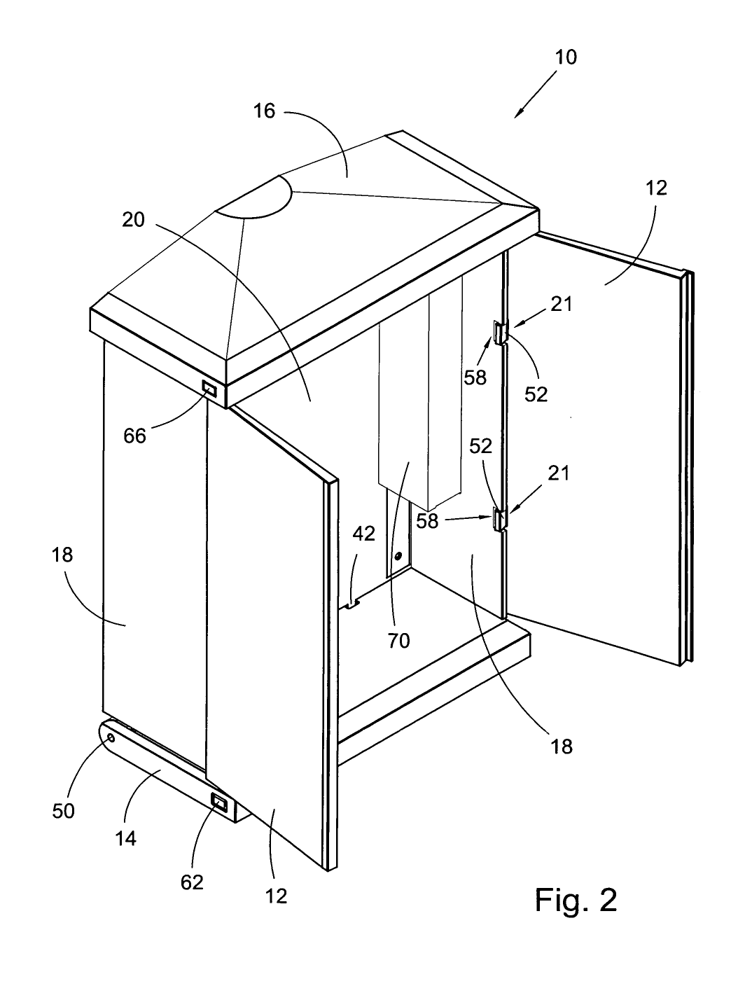

Adverting now to the figures, FIG. 1 shows a perspective view of an embodiment of present invention convertible trailer 10 in a storage configuration including doors 12 in closed positions, while FIG. 2 shows a perspective view of an embodiment of convertible trailer 10 in a storage configuration including doors 12 in open positions. In this configuration, tailgate 14 forms the base, front portion 16 forms the roof and side walls 18 form the side walls and are connected to platform 20 which forms the back wall of trailer 10. Furthermore, doors 12 are pivotally secured to side walls 18 via hinges 21. As can be seen in FIGS. 1 and 2, when trailer 10 is positioned in an upright, or storage configuration, trailer 10 has the appearance of a storage shed/container, and not a trailer. One of ordinary skill in the art will recognize that convertible trailer 10 may also include at least one shelf (not shown) detachably or fixedly secured perpendicular to and between side walls 18.

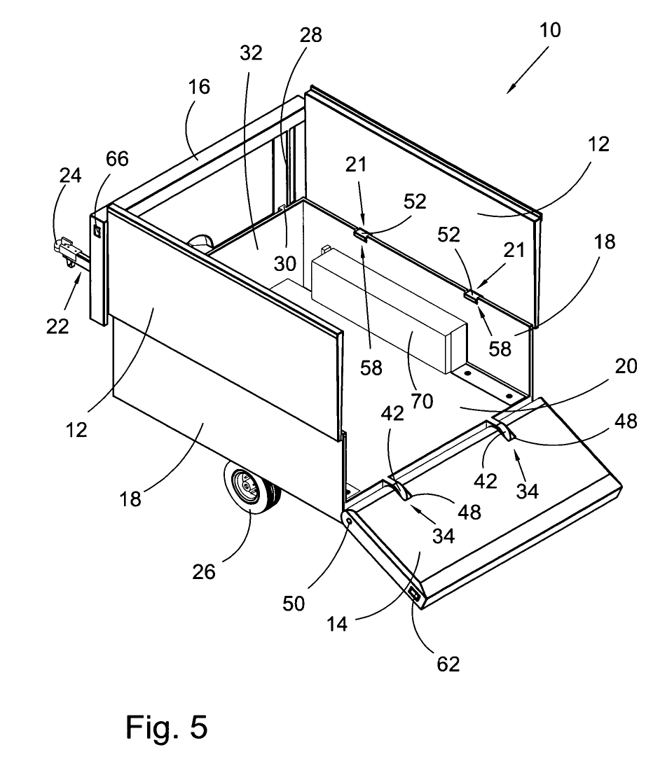

FIGS. 3, 4 and 5 show trailer 10 in a towing configuration. FIG. 3 is a perspective view of an embodiment of convertible trailer 10 in a towing configuration including doors 12 in closed positions, while FIG. 4 is a perspective view of trailer 10 in a towing configuration including doors 12 in open positions and front portion 16 in an extended position and FIG. 5 is a perspective view of trailer 10 in a towing configuration including doors 12 and tailgate 14 in open positions and front portion 16 in an extended position. When trailer 10 is in a towing configuration, tow arm 22 is extended and operatively arranged to be releasably secured to a vehicle (not shown) via ball hitch 24. Although trailer 10 is shown including ball hitch 24, one of ordinary skill in the art will recognize that other means of coupling trailer 10 to a vehicle are also possible, e.g., a two inch square receiver configuration, and such variations are within the spirit and scope of the claimed invention. Additionally, in a towing configuration, wheels 26 are in an extended position and arranged to support trailer 10.

As can be seen in FIG. 4, when trailer 10 is used in a towing configuration, doors 12 and front portion 16 may be opened and expanded, respectively, thereby increasing the volume of trailer 10 for added capacity and/or providing greater protection from air currents during movement of trailer 10. In other words, in the embodiment shown in FIG. 4, additional material or objects may be placed within trailer 10 and the likelihood of loss of objects from within trailer 10 during transit is decreased. As can be seen in FIG. 5, slots 28 of front portion 16 are slideably engaged with dovetails 30 of front wall 32. Although, front portion 16 is shown to slideably engage front wall 32, one of ordinary skill in the art will recognize that other methods of joining front portion 16 and front wall 32 are also possible, e.g., fixedly securing the two elements or pivotal connection via a hinge, and such embodiments are within the spirit and scope of the claimed invention. Additionally, tailgate 14 is pivotally secured to platform 20 via hinges 34, thereby permitting tailgate 14 to be arranged in a closed position (see FIG. 4) and an open position (see FIG. 5). As can be appreciated in view of FIGS. 2 and 4, when tailgate 14 is arranged in a closed position and trailer 10 is in a storage configuration, tailgate 14 provides a substantially planar surface that can function as a floor for trailer 10, while when trailer 10 is in a towing configuration, tailgate 14 provides a tailgate for trailer 10.

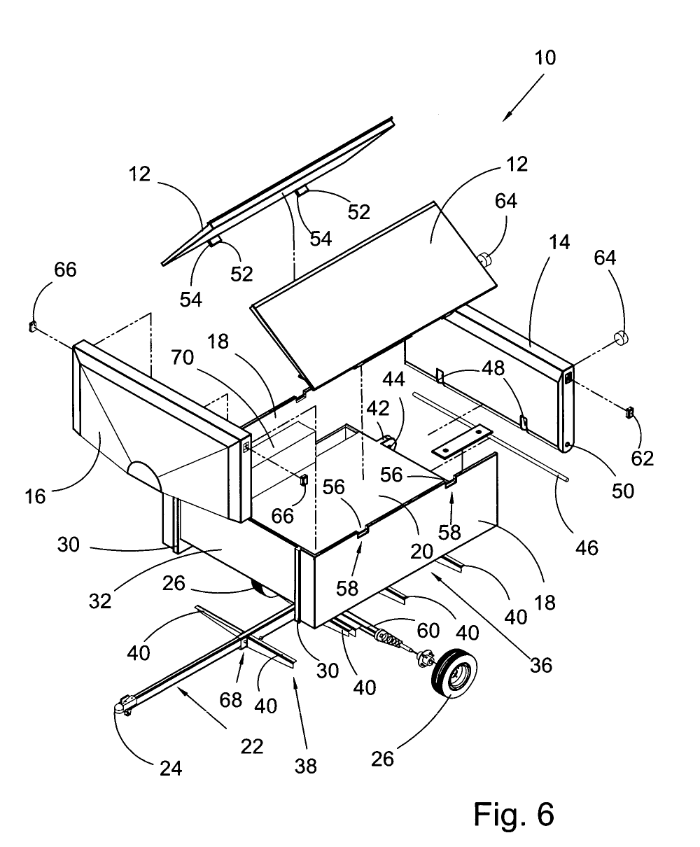

FIG. 6 shows an exploded view of an embodiment of convertible trailer 10 in a towing configuration. The following discussion is best understood in view of FIGS. 1 through 6. Main body 36 is fixedly secured to trailer frame 38 via frame arms 40. Main body 36 comprises platform 20, side walls 18 and front wall 32, each integral to the others. When trailer 10 is in a towing configuration as shown in FIG. 6, platform 20 functions as a floor, side walls 18 function as side walls, and front wall 32 functions as a front wall. When trailer 10 is in a storage configuration as shown in FIG. 2, platform 20 functions as a back wall, side walls 18 function as side walls, and front wall 32 (not shown) functions as a top wall. As described supra, tailgate 14 is pivotally secured to main body 36 via hinges 34. Hinges 34 comprise hinge flanges 42 having hole 44 arranged therethrough in combination with hinge pin 46. Tailgate 14 includes slots 48 which are complimentary to hinge flanges 42. Additionally, tailgate 14 includes through-hole 50 disposed therein. Thus, tailgate 14 is pivotally secured to hinge flange 42 by positioning slots 48 about hinge flanges 42 so that holes 44 and through-hole 50 are aligned, and subsequently inserting hinge pin 46 through through-hole 50 and holes 44. Similarly, doors 12 are pivotally secured to main body 36 via hinges 21. Hinges 21 comprise hinge flanges 52 having hole 54 arranged therethrough in combination with hinge pin 56. Main body 36 includes slots 58 which are complimentary to hinge flanges 52 and each has an individual hinge pin 56 disposed therein. Thus, doors 12 are pivotally secured to hinge flanges 52 by positioning hinge flanges 52 within slots 58 so that holes 54 are aligned with hinge pins 56. The nature and mode of operation of axle 60 is described infra.

As trailer 10 is intended to be both a storage unit and trailer, some embodiments of trailer 10 incorporate various safety features necessary for road use. For example, tailgate 14 may include side reflectors 62 and/or rear reflectors 64. In like fashion, front portion 16 may include side reflectors 66. As one of ordinary skill in the art will recognize, other safety features may be included, e.g., brake lights, and such variations are within the spirit and scope of the claimed invention.

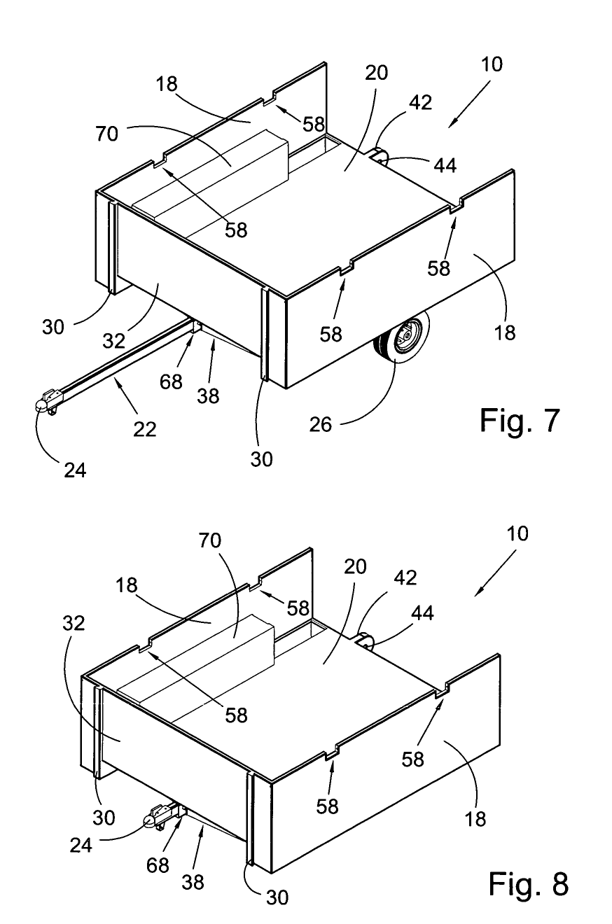

FIG. 7 is a perspective view of convertible trailer 10 in a towing configuration showing only main body 36 secured to trailer frame 38 and having tow arm 22 and wheels 26 in extended positions, while FIG. 8 is a perspective view of convertible trailer 10 in a towing configuration showing only main body 36 secured to trailer frame 38 and having tow arm 22 and wheels 26 in retracted positions. The following discussion is best understood in view of FIGS. 6 through 8. It should be appreciated that when referring to the conditions of tow arm 22, axle 60 and wheels 26, “up” means the same as “retracted” and “down” means the same as “extended”. Trailer frame 38 includes channel 68 operatively arranged to receive tow arm 22 for telescopic movement therein. In other words, when it is desired to convert trailer 10 from a towing configuration to a storage configuration, tow arm 22 is moved inwardly into channel 68 of trailer frame 38 (see FIG. 8), thereby permitting rotation of wheels 26 into the opening formed by wheel wells 70. Contrarily, when it is desired to convert trailer 10 from a storage configuration to a towing configuration, tow arm 22 is moved outwardly from channel 68 of trailer frame 38 (see FIG. 7), thereby permitting rotation of wheels 26 out from the opening formed by wheel wells 70. It should be further appreciated that when wheels 26 are rotated to an up or retracted position, wheels 26 are positioned fully within wheel wells 70. In other words, when wheels 26 are in a retracted position, platform 20 forms a substantially planar base, i.e., wheels 26 do not extend past the plane formed by platform 20. The nature and mode of operation of the rotation of wheels 26 is described in greater detail infra.

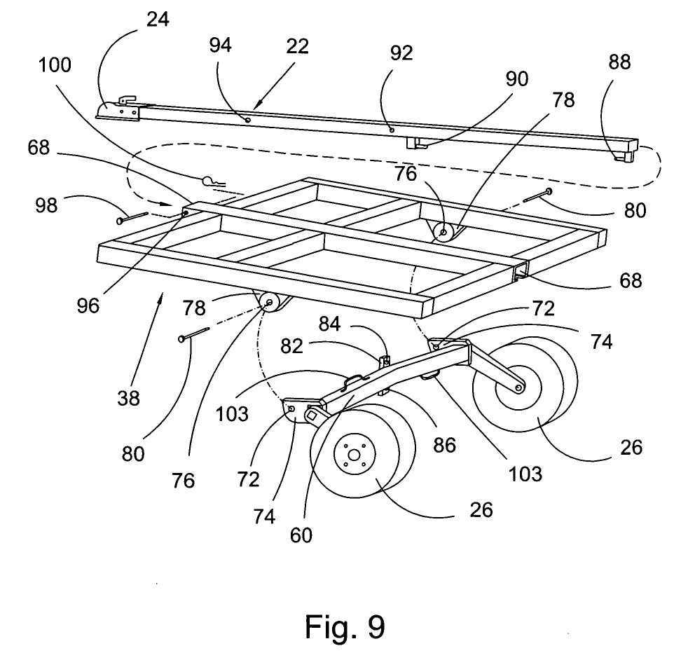

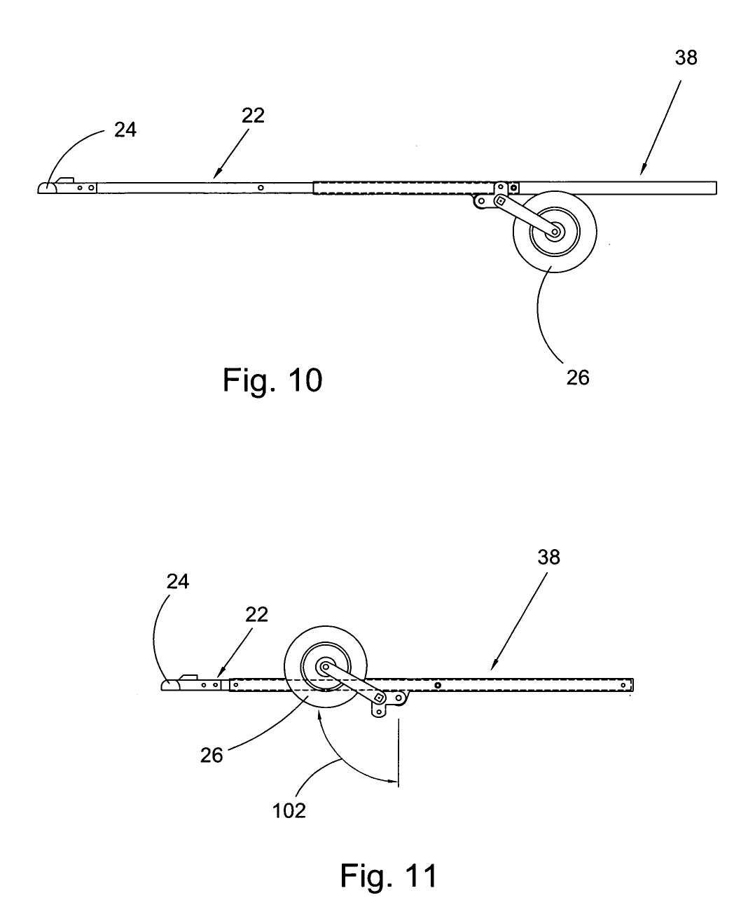

FIG. 9 shows an exploded view of an embodiment of convertible trailer 10 having tow arm 22 arranged for telescopic movement within channel 68 of trailer frame 38, FIG. 10 is a side elevational view of convertible trailer 10 having tow arm 22 and axle 60 in an extended position, and FIG. 11 is a side elevational view of convertible trailer 10 having tow arm 22 and axle 60 in a retracted position. The following discussion is best understood in view of FIGS. 9 through 11. Holes 72 of brackets 74 are aligned with holes 76 of brackets 78 and subsequently pins 80 are disposed within holes 72 and 76 thereby rotatably securing axle 60 to trailer frame 38. Axle 60 further includes locking bracket 82 having extended and retracted locking holes 84 and 86, respectively, while tow arm 22 includes extended and retracted locking pins 88 and 90, respectively, and extended and retracted locking holes 92 and 94, respectively. When convertible trailer 10 is in a towing configuration, tow arm 22 and axle 60 are in extended positions (see FIG. 10). Thus, in a towing configuration, axle 60 is rotated and tow arm 22 telescoped so that extended locking pin 88 is engaged within extended locking hole 84 and extended locking hole 92 is aligned with frame locking hole 96. Tow arm 22 is releasably secured within channel 68 by disposing tow arm locking pin 98 within extended locking hole 92 and frame locking hole 96. Subsequently, tow arm locking pin 98 is retained with cotter pin 100. Contrarily, when convertible trailer 10 is in a storage configuration, tow arm 22 and axle 60 are in retracted positions (see FIG. 11), i.e., axle 60 rotates according to bi-directional arrow 102. Thus, in a storage configuration, axle 60 is rotated and tow arm 22 telescoped so that retracted locking pin 90 is engaged within retracted locking hole 86 and retracted locking hole 94 is aligned with frame locking hole 96. Tow arm 22 is releasably secured within channel 68 by disposing tow arm locking pin 98 within retracted locking hole 94 and frame locking hole 96. Subsequently, tow arm locking pin 98 is retained with cotter pin 100. Handles 103 are included to provide a user a convenient means to assist with rotating axle 60, between extended and retracted positions, and vice versa. Although two handles 103 are shown, one of ordinary skill in the art will recognize that more or less handles may be included, e.g., one or four, and such variations are within the spirit and scope of the claims.

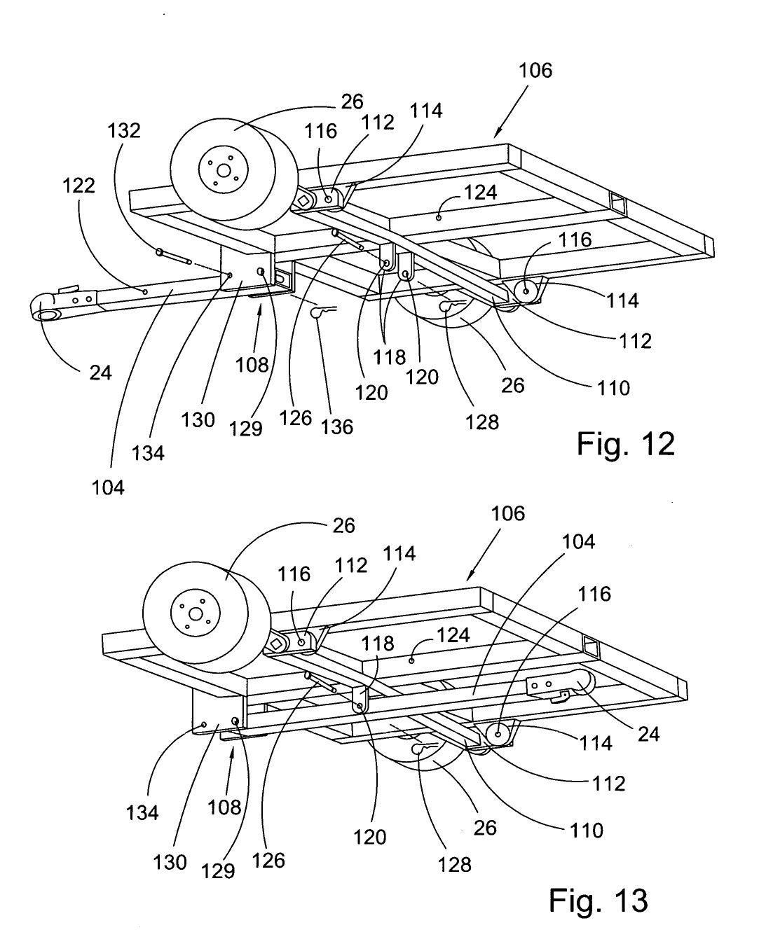

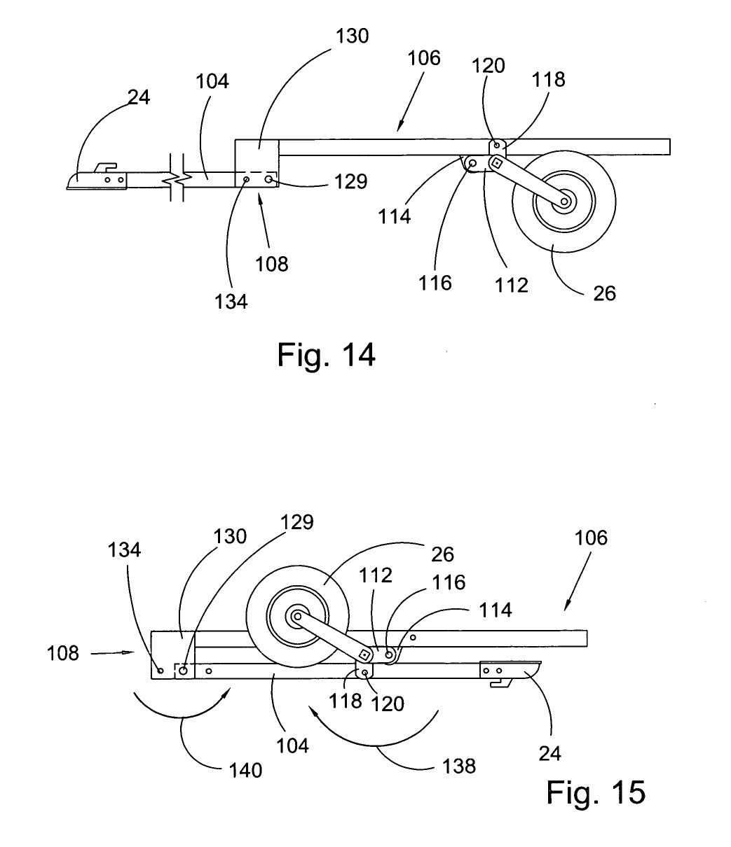

As described supra, in the embodiments shown in FIGS. 3 through 11, tow arm 22 is a telescoping arm, i.e., tow arm 22 is converted from an extended position to a retracted position by sliding tow arm 22 within channel 68 of trailer frame 38. FIGS. 12 through 15 show further embodiments of present invention trailer 10 which include tow arm 104 pivotally secured to trailer frame 106 via hinge 108. FIG. 12 is a perspective view of an embodiment of convertible trailer 10 having tow arm 104 pivotally secured via hinge 108 in an extended position and axle 110 in a retracted position, while FIG. 13 is a perspective view of another embodiment of convertible trailer 10 having tow arm 104 pivotally secured via hinge 108 in a retracted position and axle 110 in a retracted position. Additionally, FIG. 14 is a side elevational view of yet another embodiment of convertible trailer 10 having tow arm 104 and axle 110 in extended positions, while FIG. 15 is a side elevational view of still another embodiment of convertible trailer 10 having tow arm 104 and axle 110 in retracted positions.

The following discussion is best understood in view of FIGS. 12 through 15. Similar to the embodiments described above, brackets 112 are aligned with brackets 114 and subsequently pins 116 are disposed therethrough, thereby rotatably securing axle 110 to trailer frame 106. Axle 110 further includes locking bracket 118 having locking holes 120 while tow arm 104 includes retracted locking hole 122. When convertible trailer 10 is in a towing configuration, tow arm 104 and axle 110 are in extended positions (see FIG. 14). Thus, in a towing configuration, axle 110 is rotated so that locking holes 120 are aligned with extended locking hole 124 and subsequently, locking pin 126 is releasably secured through holes 120 and extended locking hole 124 with cotter pin 128. Additionally, in a towing configuration, tow arm 104 is rotated about hinge pin 129 to an extended position and releasably secured to bracket 130 by inserting locking pin 132 through hole 134, and subsequently retaining locking pin 132 therein via cotter pin 136. Contrarily, when convertible trailer 10 is in a storage configuration, tow arm 104 and axle 110 are in retracted positions (see FIG. 15), i.e., axle 110 rotates according to directional arrow 138 and tow arm 104 rotates according to directional arrow 140. Thus, in a storage configuration, axle 110 is rotated about pins 116 and tow arm 104 is rotated about hinge pin 129 so that locking holes 120 are aligned with retracted locking hole 122 and subsequently, locking pin 126 is releasably secured through holes 120 and retracted locking hole 122 with cotter pin 128.

Thus, it is seen that the objects of the present invention are efficiently obtained, although modifications and changes to the invention should be readily apparent to those having ordinary skill in the art, and these modifications are intended to be within the spirit and scope of the invention as claimed.

What is claimed is:

1. An apparatus which can be configured to be a trailer and a shed, comprising:
a trailer frame;
a trailer hitch arm collapsably connected to said trailer frame;
a floor attached substantially planar with said frame;
at least two side walls connected to said floor, wherein said walls are arranged perpendicular to said floor;
at least one door attached to one of said side walls by a first hinge;
a tailgate attached to said trailer by a second hinge, wherein said tailgate provides a substantially planar surface that can function as a floor for said shed and a tailgate for said trailer; and,
an axle having at least two wheels, said axle pivotably connected to said trailer frame, wherein said axle pivots into a down position to provide said trailer with an extended axle and wheels, and said axle pivots into an up position to provide said trailer with a substantially planar base with a retracted axle and wheels.

2. The apparatus of claim 1, further comprising at least one shelf detachably positioned between, and perpendicular to, said side walls.

3. The apparatus of claim 1, further comprising a retaining element to hold said axle in said down or up position.

4. The apparatus of claim 1, further comprising at least one handle attached to said axle operatively arranged to assist in pivoting said axle into said up position.

5. The apparatus of claim 1, further comprising at least one handle attached to said axle, operatively arranged to assist in pivoting said axle into said down position.

6. The apparatus of claim 1, wherein collapsing said trailer hitch arm toward said frame locks said axle in said up position.

7. The apparatus of claim 1, wherein said trailer hitch arm is pivotably connected to said trailer frame.

8. The apparatus of claim 1, wherein said trailer hitch arm is telescopically connected to said trailer frame.

9. The apparatus of claim 8, wherein said telescoping trailer hitch arm locks said axle in said up position when said trailer hitch arm is telescoped inwardly, and said trailer hitch arm locks said axle in said down position when said trailer hitch arm is telescoped outwardly.

10. An apparatus, comprising:
a trailer frame;
a floor attached to said frame;
at least two side walls connected to said trailer frame;
a rear wall pivotably connected to said trailer frame;
a trailer hitch arm collapsably connected to said trailer frame, distal to said rear wall; and,
an axle having at least two wheels, said axle pivotably connected to said trailer frame having a retracted and an extended position, wherein in a trailer orientation said trailer frame is horizontally oriented, said trailer hitch arm is extended, and said axle is in said extended position, and wherein in a shed orientation said trailer frame is vertically oriented, said trailer hitch arm is collapsed, and said axle is in said retracted position.

11. The apparatus of claim 10, further comprising at least one shelf detachably positioned between, and perpendicular to, said side walls.

12. The apparatus of claim 10, further comprising at least one door attached to one of said side walls by a hinge.

13. The apparatus of claim 10, further comprising a retaining element to hold said axle in said retracted or extended positions.

14. The apparatus of claim 10, wherein collapsing said trailer hitch arm adjacent to said frame locks said axle in said retracted position.

15. The apparatus of claim 10, further comprising at least one handle attached to said axle operatively arranged to assist in pivoting said axle into said retracted position.

16. The apparatus of claim 10, further comprising at least one handle attached to said axle operatively arranged to assist in pivoting said axle into said extended position.

17. The apparatus of claim 10, wherein said trailer hitch arm is pivotably connected to said trailer frame.

18. The apparatus of claim 10, wherein said trailer hitch arm is telescopically connected to said trailer frame.

19. The apparatus of claim 18, wherein said trailer hitch arm locks said axle in said retracted position when said trailer hitch arm is telescoped inwardly, and said trailer hitch arm locks said axle in said extended position when said trailer hitch arm is telescoped outwardly.

20. An apparatus which can be configured to be a trailer and a shed, comprising:
a trailer frame;
a floor attached substantially planar with said frame;
at least two side walls connected to said floor, wherein said walls are arranged perpendicular to said floor;
a tailgate attached to said trailer by a hinge, wherein said tailgate provides a substantially planar surface that can function as a floor for said shed and a tailgate for said trailer;
an axle having at least two wheels, said axle pivotably connected to said trailer frame, wherein said axle pivots into a down position to provide said trailer with an extended axle and wheels, and said axle pivots into an up position to provide said trailer with a substantially planar base with a retracted axle and wheels; and,
a trailer hitch arm telescopically connected to said trailer frame, wherein said trailer hitch arm locks said axle in said up position when said trailer hitch arm is telescoped inwardly, and said trailer hitch arm locks said axle in said down position when said trailer hitch arm is telescoped outwardly.

21. An apparatus which can be configured to be a trailer and a shed, comprising:
a trailer frame;
a floor attached substantially planar with said frame;
at least two side walls connected to said floor, wherein said walls are arranged perpendicular to said floor;
a tailgate attached to said trailer by a hinge, wherein said tailgate provides a substantially planar surface that can function as a floor for said shed and a tailgate for said trailer;
an axle having at least two wheels, said axle pivotably connected to said trailer frame, wherein said axle pivots into a down position to provide said trailer with an extended axle and wheels, and said axle pivots into an up position to provide said trailer with a substantially planar base with a retracted axle and wheels; and,
a trailer hitch arm mechanically connected to said trailer frame, wherein said trailer hitch arm is linked to said axle, wherein movement of said trailer hitch arm inwardly pivots said axle into said up position, and movement of said trailer hitch arm outwardly pivots said axle into a down position.
